(19) United States
(12) Patent Application Publication
(10) Pub. No.: US 2016/0290173 A1
(43) Pub. Date: Oct. 6, 2016

(54) ADJUSTING VALVE DRIVE MECHANISM AND STEAM TURBINE

(71) Applicants: MITSUBISHI HEAVY INDUSTRIES, LTD., Tokyo (JP); MITSUBISHI HEAVY INDUSTRIES COMPRESSOR CORPORATION, , Tokyo (JP)

(72) Inventors: Hideki TONAKA, Tokyo (JP); Naoyuki NAGAI, Tokyo (JP); Naruhito HARADA, Tokyo (JP); Makoto KATAGAKE, Hiroshima-shi (JP)

(73) Assignees: MITSUBISHI HEAVY INDUSTRIES, LTD., Tokyo (JP); MITSUBISHI HEAVY INDUSTRIES COMPRESSOR CORPORATION, Tokyo (JP)

(21) Appl. No.: 15/038,278

(22) PCT Filed: Oct. 28, 2014
(86) PCT No.: PCT/JP2014/078584

§ 371 Date: May 20, 2016

(30) Foreign Application Priority Data
Dec. 18, 2013 (JP) 2013-261807

(51) Int. Cl. F01K 13/02; F01D 17/10

(52) U.S. Cl. CPC F01K 13/02; F01D 17/10; F05D 2220/31

(57) ABSTRACT

An adjusting valve drive mechanism of a steam turbine drives an adjusting valve which opens and closes a steam channel, through which steam flows, by a valve element so as to adjust a flow rate of the steam serving as a working fluid of the steam turbine. The adjusting valve drive mechanism includes a rotary motor, a spur gear which is rotated by the rotary motor, and a chain which meshes with teeth of the spur gear, advances and retracts in a predetermined advance/retract direction which is a tangential direction of the spur gear in accordance with rotation of the spur gear, and causes the adjusting valve to advance and retract.

### TECHNICAL FIELD

The present invention relates to an adjusting valve drive mechanism of a steam turbine which is rotationally driven by steam, and a steam turbine.

Priority is claimed on Japanese Patent Application No. 2013-261807, filed Dec. 18, 2013, the content of which is incorporated herein by reference.

### BACKGROUND ART

A steam turbine is used so as to drive a machine or the like, and includes a turbine main body having a rotor which is rotatably supported. The rotor is rotationally driven by supplying steam serving as a working fluid to the turbine main body. Steam supplied to the turbine main body or steam extracted from the turbine main body flows to a steam channel of the steam turbine. An adjusting valve is provided in the steam channel. By adjusting an opening degree of the adjusting valve, it is possible to adjust the flow rate of the steam which is supplied to the turbine main body.

The adjusting valve is driven by an adjusting valve drive mechanism. For example, as described in Patent Document 1, as the adjusting valve drive mechanism, in general, a hydraulic actuator is used.

In addition, Patent Document 2 discloses a configuration in which an opening degree of an adjusting valve is adjusted via a link by an electric motor.

Moreover, for example, Patent Documents 3 and 4 disclose an adjusting valve drive mechanism which includes an electric motor, and a conversion mechanism such as a ball screw which converts a rotation movement of the electric motor into a linear movement of an adjusting valve.

### PRIOR ART DOCUMENT

### Patent Document

Patent Document 1: Japanese Unexamined Patent Application, First Publication No. H8-219322

Patent Document 2: Japanese Unexamined Utility Model Application, First Publication No. H2-29368

Patent Document 3: Japanese Unexamined Patent Application, First Publication No. 2013-72349

Patent Document 4: Japanese Unexamined Patent Application, First Publication No. H5-257538

### SUMMARY OF INVENTION

### Technical Problem

As disclosed in Patent Document 1, in the configuration which uses the hydraulic actuator, if the steam turbine is operated for a long period, a packing which is provided in a sliding portion of the hydraulic actuator deteriorates. As a result, hydraulic oil is likely to leak out from the portion of the packing. In addition, in the hydraulic actuator, since a hydraulic circuit hydraulically driven is complicated, maintenance takes a lot of time.

In the mechanism disclosed in Patent Document 2, the opening degree of the adjusting valve is adjusted via the link by the electric motor. Accordingly, a rotation amount of the electric motor and a change of the opening degree of the adjusting valve are determined by a lever ratio of the link. In this case, since a rotation range of the link is regulated by the set lever ratio, adjustment of a large opening degree may be difficult, or adjustment of a minute opening degree may be difficult.

In the configurations disclosed in Patent Documents 3 and 4, the problems in the configurations disclosed in Patent Documents 1 and 2 can be solved. However, in the configurations disclosed in Patent Documents 3 and 4, a ball screw is used. In the ball screw, a meshing portion having a predetermined contact angle is provided in a spiral screw groove. Accordingly, if opening and closing operations of the adjusting valve are repeated for a long period, only a specific portion of the meshing portion of the ball screw is abraded. Therefore, it may be necessary to perform regular maintenance with respect to the ball screw.

The present invention provides an adjusting valve drive mechanism and a steam turbine capable of increasing a degree of freedom in adjustment of an opening degree without spending time on maintenance in spite of the long-term use.

### Technical Solution

According a first aspect of the present invention, an adjusting valve drive mechanism of an adjusting valve which opens and closes a steam channel, through which steam flows, by a valve element so as to adjust a flow rate of the steam serving as a working fluid of a steam turbine, the adjusting valve drive mechanism includes: a rotary motor; a spur gear which is rotated by the rotary motor; and a straight moving portion which meshes with teeth of the spur gear, advances and retreats in a predetermined advance/retract direction which is a tangential direction of the spur gear in accordance with rotation of the spur gear, and opens and closes the adjusting valve.

In this way, since the rotary motor is used as a drive source, maintenance of a seal for preventing oil leakage of a hydraulic actuator is not required, and the amount of maintenance decreases.

In addition, since a complicated hydraulic circuit is not required, the configuration of the mechanism is simple.

Moreover, since the meshing between the spur gear and the straight movement mechanism is performed in a direction orthogonal to the advance/retract direction, unlike a case where a meshing direction is inclined to the advance/retract direction such as a thread of a ball screw or a helical gear, it is possible to decrease abrasion of the meshing portion.

In addition, since the straight moving portion is driven via the spur gear by the rotary motor, it is possible to freely adjust the opening degree of the adjusting valve by changing the rotation amount of the rotary motor.

According to a second aspect of the present invention, in the adjusting valve drive mechanism according to the first aspect, the straight moving portion may be a chain which meshes with the teeth of the spur gear and extends in the advance/retract direction from the spur gear.

According to this configuration, it is possible to advance and retract the chain by the spur gear to advance and retract the adjusting valve.

According to a third aspect of the present invention, in the adjusting valve drive mechanism according to the first aspect, the straight moving portion may be a rack gear which meshes with the teeth of the spur gear.

According to this configuration, the spur gear and the rack gear can constitute a so-called rack and pinion mechanism, and it is possible to advance and retract the rack gear by the spur gear to open and close the adjusting valve.

According to a fourth aspect of the present invention, the adjusting valve drive mechanism according to any one of the first to third aspects may further include a stage which supports the spur gear and the straight moving portion, and a position adjustment mechanism which adjusts a position of the stage along the advance/retract direction.

According to this configuration, in addition to the advance/retract operation of the adjusting valve performed by the spur gear and the straight moving portion, it is possible to perform the advance/retract operation of the adjusting valve carried by advancing and retracting the spur gear and the straight moving portion for each stage.

Moreover, the position of the adjusting valve is approximately adjusted by the advance/retract operation using the straight moving portion of the spur gear, and it is possible to perform fine adjustment of the position of the adjusting valve using the advance/retract operation of the stage.

According to a fifth aspect of the present invention, in the adjusting valve drive mechanism according to the fourth aspect, the stage may include an inclined surface which is inclined with respect to the advance/retract direction, and the position adjustment mechanism may include a drive block having an opposite surface facing the inclined surface, and a movement mechanism which moves the drive block in a direction orthogonal to the advance/retract direction.

According to this configuration, if the drive block moves in the direction orthogonal to the advance/retract direction, the inclined surface slides along the opposite surface of the drive block, and the stage moves in the advance/retract direction. Therefore, it is possible to adjust the position of the adjusting valve.

According to a sixth aspect of the present invention, in the adjusting valve drive mechanism according to the fourth or fifth aspect, the position adjustment mechanism may adjust the position of the stage by the rotary motor, and a switching portion which switches transmission of a rotary driving force of the rotary motor between the spur gear side and the position adjustment mechanism side may be provided.

According to this configuration, it is possible to share the drive source which advances and retracts the straight moving portion and the drive source which advances and retracts the stage.

According to a seventh aspect of the present invention, the adjusting valve drive mechanism according to any one of the first to sixth aspects may further include a brake which forcibly stops the rotation of the rotary motor.

Accordingly, for example, in a case where an emergency occurs or the like, it is possible to stop the rotation of the rotary motor by the brake.

According to an eighth aspect of the present invention, the adjusting valve drive mechanism according to any one of the first to seventh aspects may further include a clutch which intermittently transmits a rotating force of the rotary motor to the spur gear.

Accordingly, it is possible to intermittently transmit the rotating force of the rotary motor to the spur gear.

According to a ninth aspect of the present invention, a steam turbine, includes: a turbine main body having a blade which is rotatably supported; a steam channel which is connected to the turbine main body and through which steam flows; an adjusting valve which straightly moves and adjusts opening and closing of the steam channel; and the adjusting valve drive mechanism according to any one of the first to eighth aspects which drives the adjusting valve.

According to this configuration, the load of maintenance with respect to the adjusting valve drive mechanism of the steam turbine decreases, and the configuration of the mechanism is simple. As a result, it is possible to decrease abrasion of the meshing portion.

### Advantageous Effects

According to the above-described adjusting valve drive mechanism and the steam turbine, it is possible to increase the degree of freedom in adjustment of an opening degree without spending time on maintenance in spite of the long-term use.

### BRIEF DESCRIPTION OF DRAWINGS

FIG. 1 is a schematic view showing the entire configuration of a steam turbine according to an embodiment of the present invention.

FIG. 2 is a schematic view showing a configuration of an adjusting valve drive mechanism according to a first embodiment of the steam turbine.

FIG. 3 is a schematic view showing a configuration of an adjusting valve drive mechanism according to a second embodiment of the steam turbine.

FIG. 4 is a schematic view showing a configuration of an adjusting valve drive mechanism according to a modified example of the second embodiment of the steam turbine.

FIG. 5 is a schematic view showing a configuration of a first modified example of the adjusting valve drive mechanism.

FIG. 6 is a schematic view showing a configuration of a second modified example of the adjusting valve drive mechanism.

FIG. 7 is a schematic view showing a configuration of a third modified example of the adjusting valve drive mechanism.

FIG. 8 is a schematic view showing a configuration of a fourth modified example of the adjusting valve drive mechanism.

### DESCRIPTION OF EMBODIMENTS

Hereinafter, a steam turbine according to an embodiment of the present invention will be described with reference to the drawings.

### First Embodiment

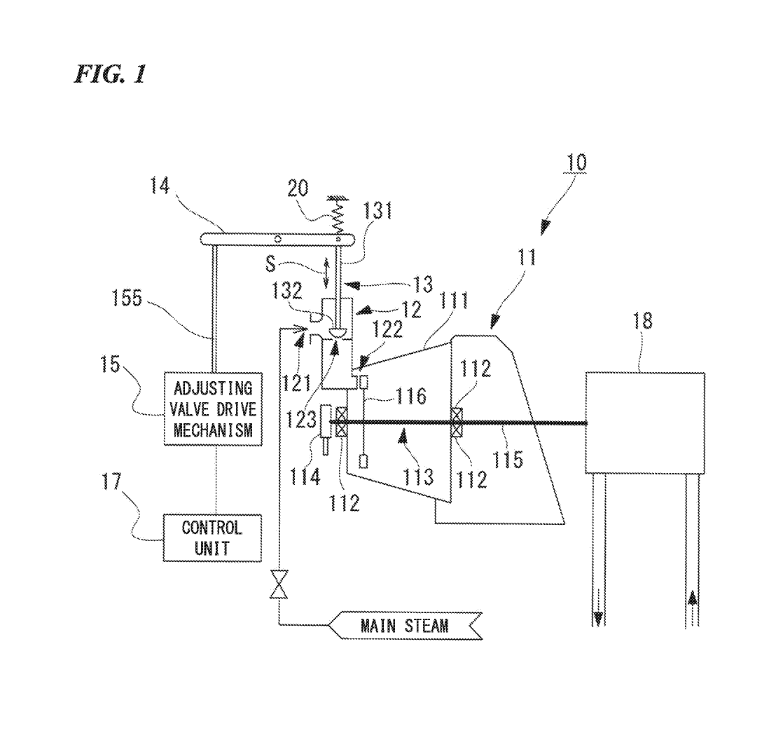

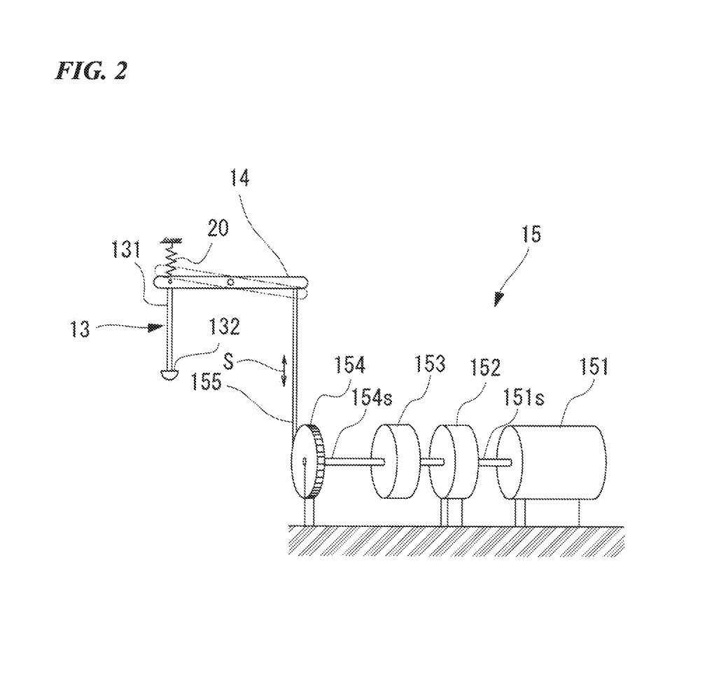

FIG. 1 is a schematic view showing a configuration of a steam turbine 10 of the present embodiment. FIG. 2 is a schematic view showing a configuration of an adjusting valve drive mechanism according to a first embodiment of the steam turbine 10.

As shown in FIG. 1, the steam turbine 10 of the present embodiment includes a turbine main body 11, a steam channel 12 through which steam serving as a working fluid flows, an adjusting valve 13, a lever member (valve element advance/retract mechanism) 14, an adjusting valve drive mechanism 15, and a control unit 17 which controls the adjusting valve drive mechanism 15.

The turbine main body 11 includes a tubular casing 111, a bearing 112 which is provided in the casing 111, a rotor 113 which is rotatably supported by the bearing 112 and is disposed inside the casing 111, and a speed detection sensor 114 which detects the rotating speed of the rotor 113. The rotor 113 includes a rotary shaft 115, and a plurality of blades 116 which are fixed to the rotary shaft 115.

The blades 116 configured as described above are rotated by steam, and a compressor 18 is driven by the rotating force.

The steam channel 12 is a channel which supplies steam serving as a working fluid to the turbine main body 11.

Steam is introduced from a steam inlet port 121 on one end side of the steam channel 12. A steam supply port 122 on the other end side of the steam channel 12 is connected to the turbine main body 11. Moreover, a throttle hole 123 in which the width of the channel is narrowed is provided between the steam inlet port 121 and the steam supply port 122. Moreover, in the present embodiment, the case is described in which the “steam channel” according to the present invention is the channel through which the steam supplied to turbine main body 11 flows. However, the steam channel 12 is not limited to this, and for example, the “steam channel” may be a channel through which steam extracted from the turbine main body 11 flows.

The adjusting valve 13 adjusts the amount of the steam which is supplied to the turbine main body 11. The adjusting valve 13 includes a rod-shaped arm member 131, and a hemispherical sealing member (valve element) 132 which is provided on the tip portion of the arm member 131. A base end portion of the arm member 131 is rotatably attached to a first end portion in a longitudinal direction of the lever member 14. Since the adjusting valve 13 has the above-described configuration, the arm member 131 linearly moves along the steam channel 12, and the sealing member 132 on the tip portion of the arm member 131 is fitted to or separated from the throttle hole 123 of the steam channel 12. Accordingly, the size of an opening between the throttle hole 123 and the sealing member 132 is changed. Therefore, the flow rate of the steam which is supplied to the turbine main body 11 via the throttle hole 123 is changed.

The lever member 14 is a member which transmits output of the adjusting valve drive mechanism 15 to the adjusting valve 13 and causes the sealing member 132 to advance toward and to retract from the steam channel 12. An intermediate portion in the longitudinal direction of the lever member 14 is rotatably supported.

In addition, one end of a biasing spring 20 is attached to the first end portion of the lever member 14. The biasing spring 20 functions as a forcibly closing means for forcibly closing the adjusting valve 13. The other end of the biasing spring 20 is fixed to a frame (not shown) of the steam channel 12 or the like so as to be immovable. That is, in a state where an external force is not applied, the biasing spring 20 rotates the lever member 14 in the clockwise direction in FIG. 1 to apply a pressing force to the lever member 14.

The adjusting valve drive mechanism 15 is a mechanism which drives the above-described adjusting valve 13.

As shown in FIG. 2, the adjusting valve drive mechanism 15 is connected to the other end of the lever member 14. The adjusting valve drive mechanism 15 rotates the lever member 14. Accordingly, the arm member 131 constituting the adjusting valve 13 is displaced in an axial direction, and an opening degree of the adjusting valve 13 is adjusted.

The adjusting valve drive mechanism 15 includes a servo motor (rotary motor) 151, a brake 152 and a clutch 153 which are connected to a drive shaft 151s of the servo motor 151, a drive gear (spur gear) 154 which is connected to the drive shaft 151s of the servo motor 151, and a chain (straight moving portion) 155 which is wound around the drive gear 154.

The brake 152 is configured of an electronic disk brake. The brake 152 is configured so as to be operated when supply of power is cut off to stop the rotation of the servo motor 151. The operation of the brake 152 is controlled by the control unit 17 (refer to FIG. 1). In a case where a circumferential speed of the drive shaft 151s exceeds a threshold value, the control unit 17 can operate the brake 152. That is, the rotation of the servo motor 151 is stopped by operating the brake 152.

The clutch 153 is provided so as to be interposed between the drive shaft 151s of the servo motor 151 and a rotary shaft 154s of the drive gear 154. The clutch 153 can perform intermittent transmission of a rotating force between the drive shaft 151 s and the rotary shaft 154s.

In a case where the operation of the clutch 153 is controlled by the control unit 17 and any abnormalities of the control unit 17 are detected, or the like, the clutch 153 stops the transmission of the rotating force between the drive shaft 151s and the rotary shaft 154s.

A meshing portion between the drive gear 154 and the chain 155 is formed by a spur gear which is positioned in a direction orthogonal to an advance/retract direction S of the chain 155. The drive gear 154 is disposed at a position separated from a second end portion of the lever member 14 in an upward-downward direction orthogonal to the longitudinal direction in which the first and second end portions of the lever member 14 are connected to each other.

One end of the chain 155 is connected to the second end portion of the lever member 14. The chain 155 is wound around the drive gear 154 so as to extend in a tangential direction of the drive gear 154. The chain 155 advances and retracts in a predetermined advance/retract direction S which becomes the tangential direction of the drive gear 154 according to the rotation of the drive gear 154. According to the advance and retract of the chain 155, the lever member 14 is swung, the arm member 131 of the adjusting valve 13 linearly moves, and the sealing member 132 of the tip portion of the arm member 131 is fitted to or separated from the throttle hole 123 of the steam channel 12. Accordingly, the flow rate steam which is supplied to the turbine main body 11 via the throttle hole 123 is changed.

The control unit 17 controls the adjusting valve drive mechanism 15 based on the pressure or the temperature of the compressor 18 detected by a sensor (not shown) or the like, the rotating speed of the drive shaft 151s of the servo motor 151, instruction from a user, or the like, and adjusts the amount of the steam supplied to the turbine main body 11.

Therefore, according to the adjusting valve drive mechanism 15 and the steam turbine 10 of the above-described first embodiment, since the servo motor 151 is used as a drive source, unlike a hydraulic actuator, a seal for preventing leakage of oil is not provided. Accordingly, it is possible to decrease the frequency of maintenance. In addition, unlike the hydraulic actuator, since a complicated hydraulic circuit is not provided, the configuration of the adjusting valve drive mechanism 15 is simple.

Therefore, maintenance of the adjusting valve drive mechanism 15 and the steam turbine 10 is easily performed, and mechanical reliability increases. As a result, the maintainability increases, and it is possible to decrease the manufacturing cost and the maintenance cost.

In addition, since the meshing between the drive gear 154 and the straight movement mechanism is performed in the direction orthogonal to the advance/retract direction S, unlike a case where a meshing direction is inclined in the advance/retract direction S such as a thread of a ball screw or a helical gear, it is possible to decrease abrasion of the meshing portion.

Moreover, since the chain 155 is driven via the drive gear 154 by the servo motor 151, it is possible to freely adjust the opening degree of the adjusting valve 13 by changing a rotation amount of the servo motor 151. Accordingly, unlike a configuration in which a link is rotated by a motor, the degree of freedom in the adjustment of the opening degree of the adjusting valve 13 increases.

### Second Embodiment

Next, a second embodiment of the adjusting valve drive mechanism 15 and the steam turbine 10 according to the present invention will be described. In the second embodiment described below, since only the configuration of the adjusting valve drive mechanism 15 is different from that of the first embodiment, the same reference numerals are assigned to the same portions as those of the first embodiment, and overlapping descriptions thereof are omitted.

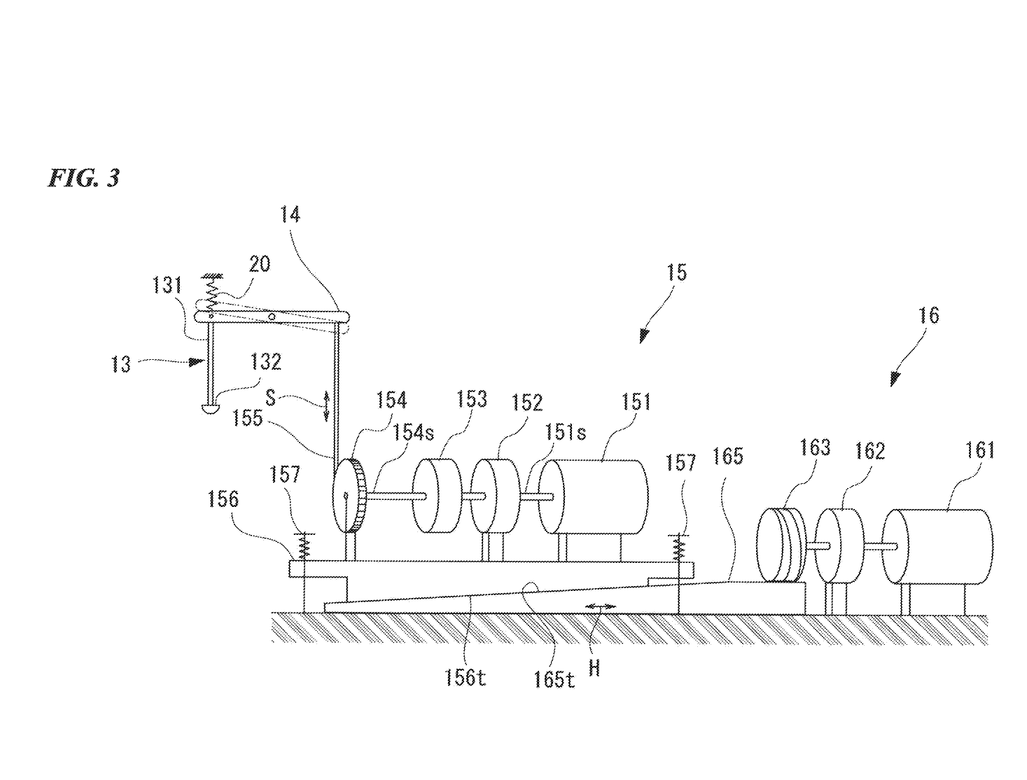

FIG. 3 is a schematic view showing the configuration of the adjusting valve drive mechanism 15 according to the second embodiment of the steam turbine 10.

As shown in FIG. 3, the adjusting valve drive mechanism 15 of the present embodiment has the same adjusting valve drive mechanism 15 as that of the first embodiment. This adjusting valve drive mechanism 15 further includes a stage 156 and a position adjustment mechanism 16.

The servo motor 151, the brake 152, the clutch 153, and the drive gear 154 which configure the adjusting valve drive mechanism 15 are provided on the stage 156. The stage 156 has an inclined surface 156t, which is inclined with respect to the advance/retract direction S, on the lower surface of the stage 156. The position adjustment mechanism 16 adjusts the position of the stage 156 in the advance/retract direction S. The position adjustment mechanism 16 includes a drive block 165 which is disposed below the stage 156 and has an opposite surface 165t facing the inclined surface 156t, and a movement mechanism which moves the drive block 165 in a direction H orthogonal to the advance/retract direction S and includes a servo motor 161, a brake 162, and a drive gear 163.

Here, the reduction ratio of the drive gear 154, the inclination angle of the inclined surface 156t, the reduction ratio of the drive gear 163, or the like is set such that the adjustment amount (adjustment speed) of the adjusting valve 13 in the position adjustment mechanism 16 driven by the servo motor 161 is smaller than the adjustment amount (adjustment speed) of the adjusting valve 13 in the adjusting valve drive mechanism 15 driven by the servo motor 151. For example, the drive gear 163 can use a worm gear.

Therefore, according to the adjusting valve drive mechanism 15 of the above-described second embodiment, in addition to the advance/retract operation of the adjusting valve 13 performed by the drive gear 154 and the chain 155, the advance/retract operation of the adjusting valve 13 which is performed by advancing and retracting the drive gear 154 and the chain 155 for each stage 156 is performed. As a result, the position of the adjusting valve 13 is approximately adjusted by the advance/retract operation performed by the chain 155 of the drive gear 154, and the position of the adjusting valve 13 can be finely adjusted by the advance/retract operation of the stage 156.

Moreover, similarly to the first embodiment, since the servo motors 151 and 161 are used as the drive sources, maintenance does not take much time in spite of the long-term use, and it is possible to increase the degree of freedom in the adjustment of the opening degree of the adjusting valve 13 at low cost.

In addition, since the adjustment of the opening degree of the adjusting valve 13 is performed at two stages such as coarse adjustment and fine adjustment, it is possible to more rapidly adjust the opening degree with high accuracy.

### Modified example of Second Embodiment

Here, in the second embodiment, the stage 156 is driven by the servo motor 161 which is provided separately from the servo motor 151. However, the present invention is not limited to this.

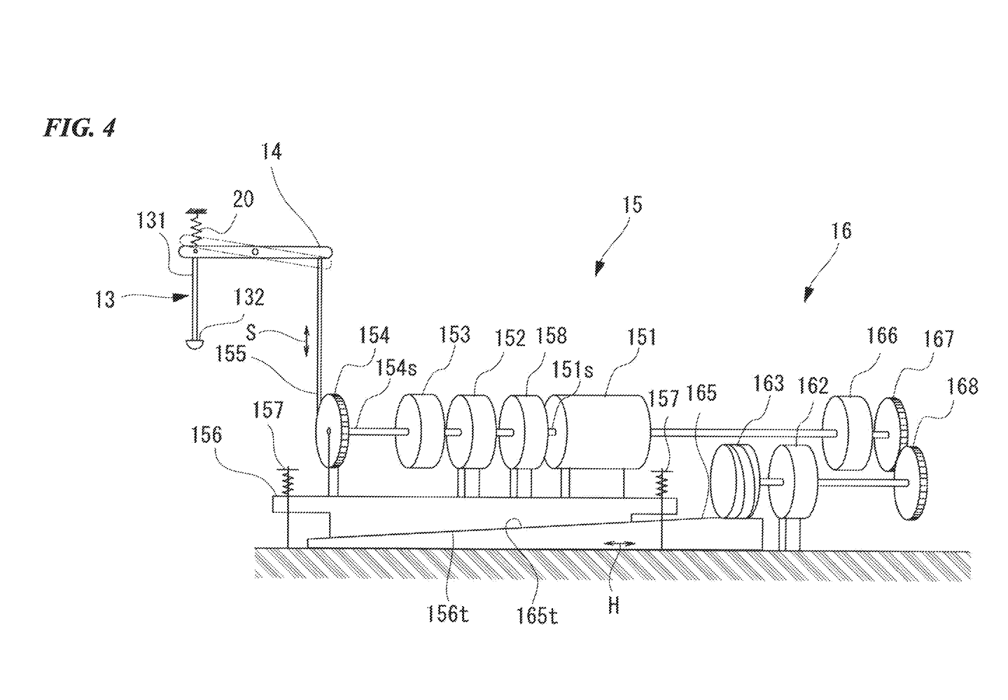

FIG. 4 is a schematic view showing a configuration of an adjusting valve drive mechanism in a modified example of the second embodiment of the steam turbine.

As shown in FIG. 4, the stage 156 may be configured so as to be driven by the servo motor 151 which drives the chain 155. That is, the drive gear 163 is connected to the servo motor 151 via a clutch (switching portion) 166, transmission gears 167 and 168, and the brake 162. In addition, in the servo motor 151, a clutch (switching portion) 158 is also provided on the drive gear 154 side.

In this configuration, a transmission destination of a rotary driving force of the servo motor 151 can be selectively switched to the drive gear 154 and the drive gear 163 by operating the clutches 158 and 166.

According to this configuration, since the drive source which advances and retracts the chain 155 and the drive source which advances and retracts the stage 156 can be shared, the configuration can be simple, and the cost can decrease.

### Other Modified Examples

In addition, the present invention is not limited to the above-described embodiments, and various modifications are applied to the above-described embodiments within a scope which does not depart from the gist of the present invention. That is, specific shapes, configurations, or the like described in the embodiments are examples, and may be appropriately modified.

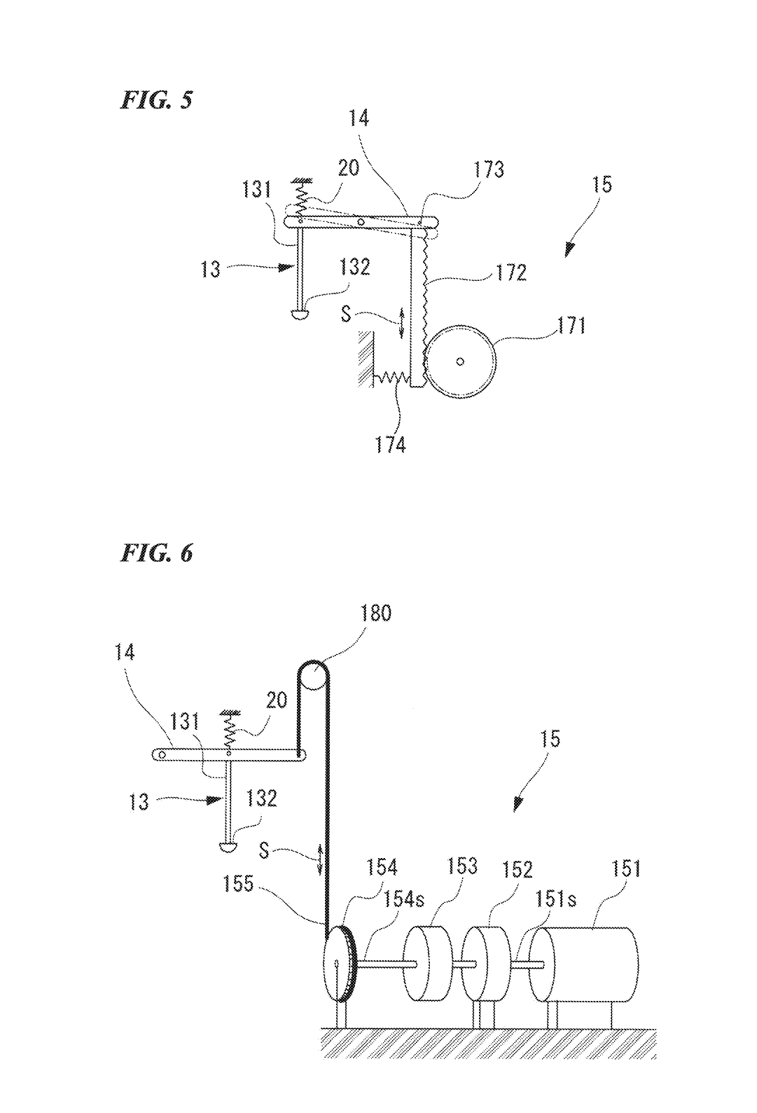

For example, FIG. 5 is a schematic view showing a configuration of a first modified example of the adjusting valve drive mechanism.

As shown in FIG. 5, instead of the drive gear 154 and the chain 155, a pinion gear 171 and a rack gear 172 can be used as the spur gear and the straight moving portion. In this case, in order to follow the swinging of the lever member 14, the upper end portion of the rack gear 172 is connected to the lever member 14 by a pin 173. In the adjusting valve drive mechanism 15 of the first modification, for example, in order to press the lever member 14 to the pinion gear 171, preferably, a pressing member 174 such as a spring is provided.

Moreover, for example, as a second modified example shown in FIG. 6, in a case where the first end portion in the longitudinal direction of the lever member 14 is rotatably supported and the adjusting valve 13 is provided on the intermediate portion in the longitudinal direction of the lever member 14, or the like, a folding gear 180 may be provided on the upper portion such that the chain 155 is folded and the tip portion of the lever member 14 is advanced and retracted from the upper portion.

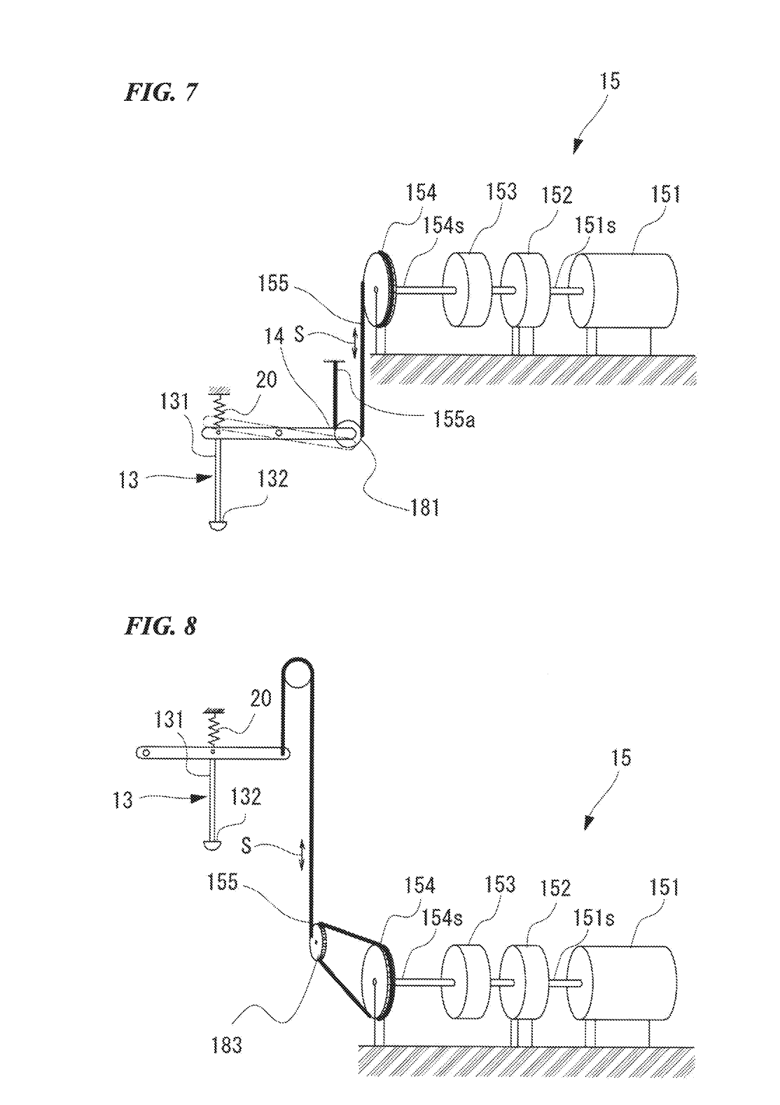

Moreover, as a third modified example shown in FIG. 7, a pulley gear 181 which functions as a free pulley may be provided on the tip portion of the lever member 14, one end 155a of the chain 155 and the drive gear 154 may be fixed above the pulley gear 181, and the intermediate portion of the chain 155 is wound around the pulley gear 181. Accordingly, it is possible to decrease the rotating force of the servo motor 151.

In addition, as a fourth modified example shown in FIG. 8, a transmission gear 183 having different diameters may be interposed between the drive gear 154 and the chain 155 so as to increase or decrease the rotating force of the servo motor 151 and transmit the force to the drive gear 154. Accordingly, it is possible to decrease application torque of the servo motor 151, and it is possible to suitably set capacity of the servo motor 151.

Moreover, the entire configuration or the like of the adjusting valve drive mechanism 15 or the steam turbine 10 may be appropriately modified if it is within the scope of the gist of the present invention.

### INDUSTRIAL APPLICABILITY

According to the adjusting valve drive mechanism or the steam turbine, it is possible to increase the degree of freedom in adjustment of the opening degree without spending time on maintenance in spite of the long-term use.

### REFERENCE SIGNS LIST

10: steam turbine
11: turbine main body
12: steam channel
13: adjusting valve
14: lever member
15: adjusting valve drive mechanism
16: position adjustment mechanism
17: control unit
116: blade
131: arm member
132: sealing member (valve element)
151: servo motor (rotary motor)
151s: drive shaft
152: brake
153: clutch
154: drive gear (spur gear)
155: chain (straight moving portion)
156: stage
156t: inclined surface
165: drive block
158, 166: clutch (switching portion)
171: pinion gear (spur gear)
172: rack gear (straight moving portion)

1. An adjusting valve drive mechanism of an adjusting valve which opens and closes a steam channel, through which steam flows, by a valve element so as to adjust a flow rate of the steam serving as a working fluid of a steam turbine, the adjusting valve drive mechanism comprising:
a rotary motor;
a spur gear which is rotated by the rotary motor;
a straight moving portion which meshes with teeth of the spur gear, advances and retreats in a predetermined advance/retract direction which is a tangential direction of the spur gear in accordance with rotation of the spur gear, and opens and closes the adjusting valve;
a stage which supports the spur gear and the straight moving portion; and
a position adjustment mechanism which adjusts a position of the stage along the advance/retract direction.

2. The adjusting valve drive mechanism according to claim 1,
wherein the straight moving portion is a chain which meshes with the teeth of the spur gear and extends in the advance/retract direction from the spur gear.

3. The adjusting valve drive mechanism according to claim 1,
wherein the straight moving portion is a rack gear which meshes with the teeth of the spur gear.

4. (canceled)

5. The adjusting valve drive mechanism according to claim 1,
wherein the stage includes an inclined surface which is inclined with respect to the advance/retract direction, and
wherein the position adjustment mechanism includes a drive block having an opposite surface facing the inclined surface, and a movement mechanism which moves the drive block in a direction orthogonal to the advance/retract direction.

6. The adjusting valve drive mechanism according to claim 1,
wherein the position adjustment mechanism adjusts the position of the stage by the rotary motor, and
wherein a switching portion which switches transmission of a rotary driving force of the rotary motor between the spur gear side and the position adjustment mechanism side is provided.

7. The adjusting valve drive mechanism according to claim 1, further comprising:
a brake which forcibly stops the rotation of the rotary motor.

8. The adjusting valve drive mechanism according to claim 1, further comprising:
a clutch which intermittently transmits a rotating force of the rotary motor to the spur gear.

9. A steam turbine, comprising:
a turbine main body having a blade which is rotatably supported;
a steam channel which is connected to the turbine main body and through which steam flows;
an adjusting valve which straightly moves and adjusts opening and closing of the steam channel; and
the adjusting valve drive mechanism according to claim 1 which drives the adjusting valve.
